(19) United States
(12) Patent Application Publication
(10) Pub. No.: US 2016/0354717 A1
(43) Pub. Date: Dec. 8, 2016

(54) Automatic Cylindrical Air Filter Cleaning Device

(71) Applicant: Shane Greeley, North Platte, NE (US)

(72) Inventor: Shane Greeley, North Platte, NE (US)

(21) Appl. No.: 15/172,104

(22) Filed: Jun. 2, 2016

Related U.S. Application Data
(60) Provisional application No. 62/170,683, filed on Jun. 4, 2015.

(51) Int. Cl. B01D 46/00; B01D 46/24

(52) U.S. Cl. CPC B01D 46/0068; B01D 46/2403

(57) ABSTRACT

An automatic cylindrical air filter cleaning device and method is disclosed. The device comprises a support frame, two parallel rollers mounted to the support frame for receiving a cylindrical air filter to be cleaned, a V-belt drive, motor-and-pulley assembly mounted to the support frame, wherein the V-belt is fastened to the parallel rollers to permit their rotation and the rotation of the cylindrical air filter upon activation of the motor, and an air supply apparatus mounted to the support frame, the air supply apparatus having an air inlet, and upper and lower branches each with vented holes. Air from an external air source flows into the air supply apparatus via the air inlet and then out of the upper and/or lower branches through the vented holes onto the rotating filter, causing dust and particulate matter from the filter placed on the parallel rollers to become dislodged. The device may further comprise a dust collection box placed below the rollers for collecting dust and particulate matter removed from the cylindrical air filter during the cleaning process.

### CROSS-REFERENCE TO RELATED APPLICATIONS

This application claims priority to, and the benefit of U.S. Application No. 62/170,683, filed Jun. 4, 2015, the specification of which is hereby incorporated by reference in its entirety.

### FIELD OF THE INVENTION

The present invention relates to an automatic device for cleaning cylindrical air filters used in internal combustion engines.

### BACKGROUND OF THE INVENTION

It is well known that air filters prevent particulate impurities such as abrasive dust and dirt from entering into the combustion chambers of engines. When the particulate build-up becomes significant, the air flow through the filter is restricted, causing abnormal operation of the engine. For engine-powered vehicles exposed to extreme dust, such as those used in farming and construction, the air filters become quickly fouled with particulates and must be constantly cleaned or replaced. Continual replacement is cost-prohibitive. Conventional cleaning involves manually blowing compressed air through the air filters via a hand-held wand. This has at least three disadvantages: first, because the procedure requires inserting the wand into the center of the air filters, dust ends up everywhere, particularly on the user and on the floor, which dissuades from cleaning the air filters indoors; second, the procedure is frequently interrupted by the emptying and re-filling of the compressor supplying the air; and third, the risk of damage to the air filters by virtue of the wand getting too close to the sides of the air filters.

It would therefore be desirable to provide an air filter cleaning device that is inexpensive, automated, reduces the risk of damage to the air filter, and eliminates or reduces mess.

### SUMMARY OF THE INVENTION

In one aspect of the present invention, an automatic cylindrical air filter cleaning device is provided, the device comprising a support frame, two parallel rollers mounted to the support frame for receiving the cylindrical air filter to be cleaned, a V-belt drive motor-and-pulley assembly mounted to the support frame, wherein the V-belt is fastened to the parallel rollers to permit their rotation upon activation of the motor, and an air supply apparatus mounted to the support frame for receiving air from an external source and dispensing it to dislodge dust and particulate matter from the cylindrical air filter as it rotates on the rotating parallel rollers.

The foregoing and other features and advantages will become more readily apparent from the following detailed description of the invention, which proceeds with reference to the accompanying drawings.

### BRIEF DESCRIPTION OF THE DRAWINGS

The invention will be described with reference to the following drawings of which:

FIG. 1 is a perspective view of an automatic cylindrical air filter cleaning device according to an embodiment of the present invention;

FIG. 2 is a top view of the automatic cylindrical air filter cleaning device of FIG. 1;

FIG. 3 is a side view of the automatic cylindrical air filter cleaning device of FIG. 1

FIG. 4 is a front view of the automatic cylindrical air filter cleaning device of FIG. 1;

FIG. 5 is a rear view of the automatic cylindrical air filter cleaning device of FIG. 1;

FIG. 6 is a perspective view of the support frame of the automatic cylindrical air cleaning device of FIG. 1;

FIG. 7 is a perspective view of the compressed air supply line of the automatic cylindrical air filter cleaning device of FIG. 1; and

FIG. 8 is a perspective view of the dust collection box of the automatic cylindrical air filter cleaning device of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of embodiments of the invention references the accompanying drawings. The embodiments are intended to describe aspects of the invention in sufficient detail to enable those skilled in, the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent, to those skilled in the art from the description. For example, a feature, structure, act, etc. described in one embodiment may also be included in other embodiments, but is not necessarily included. Thus, the present technology can include a variety of combinations and/or integrations of the embodiments described herein.

The terminology used herein is for the purpose of describing particular embodiments only and is not intended to be limiting of the disclosure. As, used herein, the singular forms “a,” “ ,” and “the” are intended to include the plural forms as well, unless the context clearly indicates otherwise. It will be further understood that the terms “comprises,” “comprising,” “includes,” and/or “including” when used herein specify the presence of stated features, integers. steps, operations, elements, and/or components, but do not preclude the presence or addition of one or more other features, integers, steps, operations, elements, components, and/or in groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

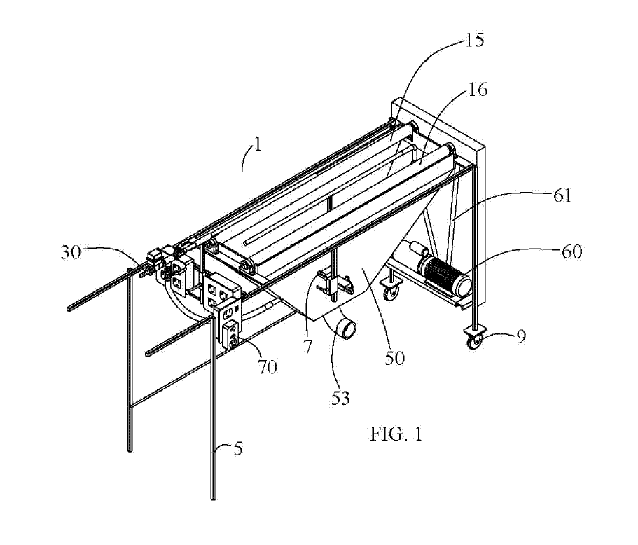

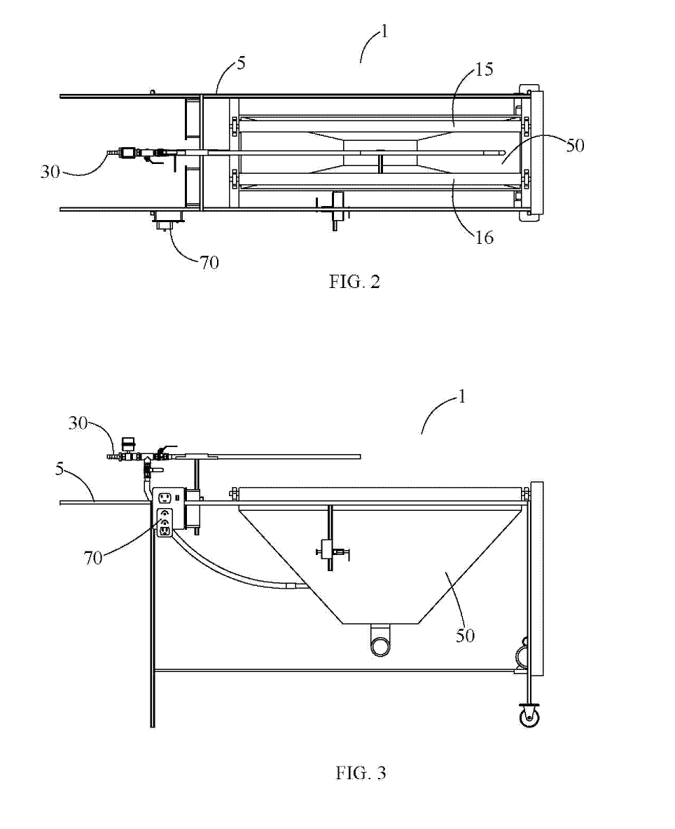

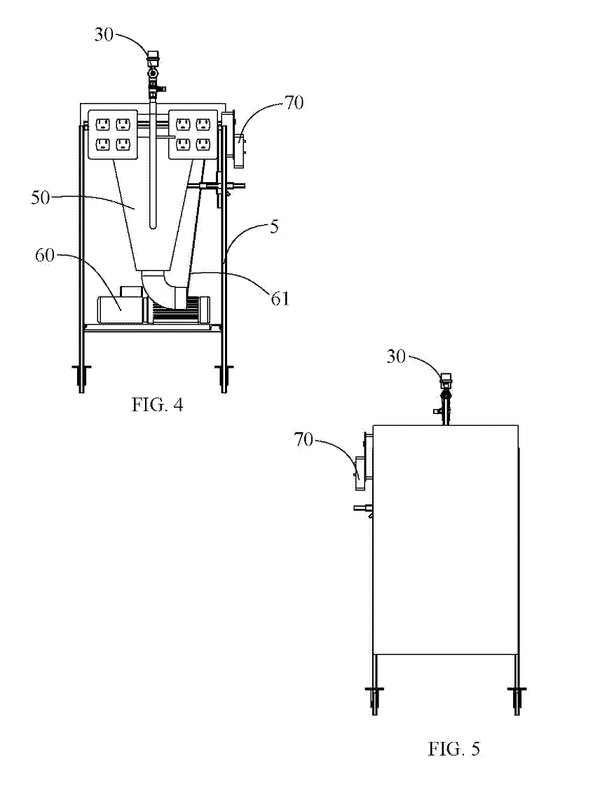

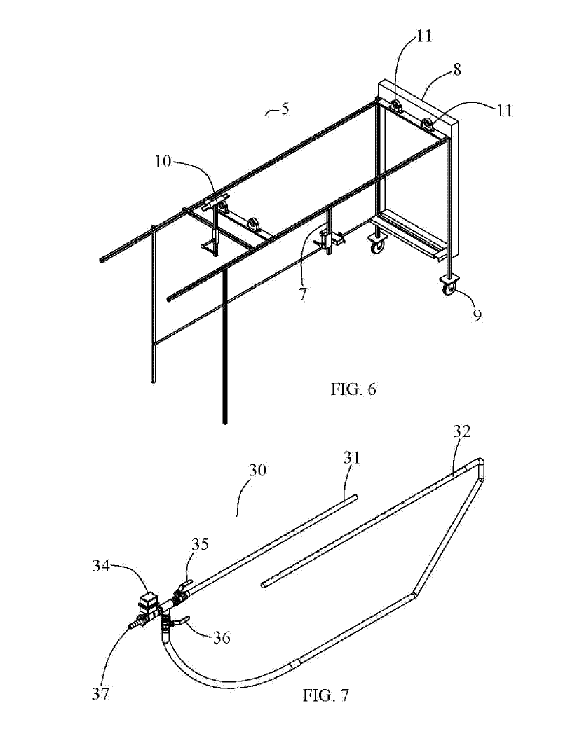

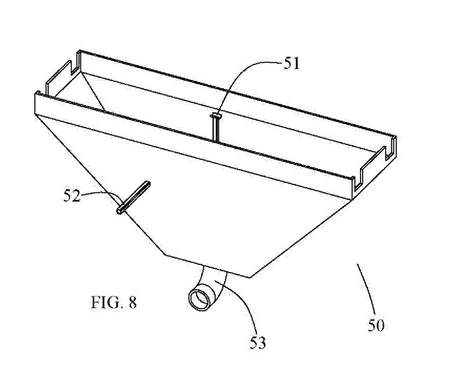

Referring to FIGS. 1-8, the automatic cylindrical air filter cleaning device 1 comprises a support frame 5, two parallel rollers 15 and 16 mounted to the support frame 5 for receiving the cylindrical air filter to be cleaned, V-belt drive motor-and-pulley assembly 60 mounted to the support frame 5, wherein the V-belt 61 is fastened to the parallel rollers 15 and 16 to permit their rotation and the rotation of the cylindrical air filter about its longitudinal axis, upon activation of the motor-and-pulley assembly 60, and an air supply apparatus 30 mounted to the support frame 5 for receiving air from an external source and dispensing it to dislodge dust and particulate matter from the cylindrical air filter as it rotates on the parallel rollers 15 and 16.

The support frame 5 is a rectangular table-type frame with four supporting legs.

The air supply apparatus 30 represents a node-and-branch arrangement of piping or tubing through which air flows. The piping or tubing may be copper, fiberglass, steel, aluminum, or plastic. In sequence, external air flows into the air supply apparatus 30 through an air inlet 37, which then branches into an upper air supply line 31 and a lower air supply line 32. An air inlet valve 37 may be installed along a section of the air inlet 37 to control the flow of air into the upper air supply line 31 and the lower air supply line 32. In a preferred embodiment, the air inlet valve 34 is a ball valve. In a most preferred embodiment, the air inlet valve 34 is a motorized ball valve. The upper air supply line 31 includes vented holes for blowing air downward, and the lower air supply line 32 includes vented holes for blowing air upward. An upper air supply line valve 35 is installed along a section of the upper air supply line 31 for further air flow control. In a preferred embodiment, the upper air supply line valve 35 is a ball valve. A lower air supply line valve 36 is installed along a section of the lower air supply line 32 for further air control. In a preferred embodiment, the lower air supply line valve 36 is a ball valve.

In a preferred embodiment, the device 1 further comprises a dust collection box 50 mounted to the support frame 5. The dust collection box 50 is positioned below the parallel rollers 15 and 16, enabling it to collect dust and particulate matter dislodged from a cylindrical air filter when the device 1 is in operation. The dust collection box 50 may include a horizontal stand 51, insert tube 52, and a vacuum connector 53. The horizontal stand 51 is configured to support the lower air supply line 32 of the air supply apparatus 30. The insert tube 52 enables the dust collection box 50 to be mounted to the support frame 5. This is accomplished by inserting the insert tube 52 into a support structure 7 mounted to the support frame 5. The vacuum connector 53 is to move out the dust from the dust collection box 50. Dust and particulate matter can be collected in the dust collection box 50 by applying a vacuum air flow below a cylindrical air filter and the parallel rollers 15 and 16 through a vacuum connector 53. The force of the vacuum flow can be controlled in the vacuum connector 53. The dust collection box 50 is mounted on the support structure 7 with mounting bracket and screws.

In a preferred embodiment, the device 1 further comprises a side bracket 8 mounted to the support frame 5. The purpose of the side bracket 8 is to close the support frame 5 to prevent the unnecessary spread of dust and particulate matter when the device 1 is in operation.

The parallel rollers 15 and>16 are mounted to the support frame 5 with bearing and housing 11.

The support frame 5 may be configured for attachment of, an electrical switch board and other electrical wirings and components for actuating the V-belt drive motor-pulley assembly 60 and controlling the flow of air through the air supply apparatus 30.

Mounted to the support frame 5 is a height adjuster 10 upon which the upper air supply line 31 of the air supply apparatus 30 is mounted.

In a preferred embodiment, the device 1 further comprises an adjustable recycle timer 70 for fixing a time interval between supplying air into the air supply apparatus 30 via the air inlet 37 from an air compressor and refilling the air compressor.

In a preferred embodiment, at least two of the supporting legs of the support frame 5 has wheels 9 making the device 1 easily movable.

To clean a cylindrical air filter using the, automatic cylindrical air filter cleaning device 1, air is supplied to the air supply apparatus 30 from an external air source via the air inlet 37, and a cylindrical air filter is slid over the upper air supply line 31 and placed on the parallel rollers 15 and 16. The parallel rollers 15 and 16, driven by the V-belt 61 upon activation of the V-belt drive motor-pulley assembly 60, cause the filter to rotate about its longitudinal axis, thereby exposing it to, air from either or both of the upper air line 31 and the lower air line 32. The height of the upper air line 31 may be adjusted with the height adjuster 11, thereby permitting the user of the system 1 to clean cylindrical air filters of varying diameters. The upper air supply line valve 35 and lower air supply line valve 36 permit the user to choose either the upper air line 31 or the lower air line 32, or both of them, to operate at a given time The air blown from either the upper air line 31 or the lower air line 32, or both of them, causes the dust and particulate matter in the filter to become dislodged, and the dust collection box 50 may be used to collect the resultant dust and particulate matter.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. An automatic cylindrical air filter cleaning device, comprising:
a support frame;
two parallel rollers mounted to the support frame for receiving the cylindrical air filter to be cleaned;
a V-belt drive motor-and-pulley assembly mounted to the support frame, wherein the V-belt is fastened to the parallel rollers to permit their rotation upon activation of the motor; and
an air supply apparatus mounted to the support frame for receiving air from an external air source and dispensing it to dislodge dust and particulate matter from the cylindrical air filter when placed and rotated on the rotating parallel rollers, wherein the air supply apparatus comprises an air inlet, an upper air supply line over which the cylindrical air filter is slid when placed on the parallel rollers, and a lower air supply line, wherein an air inlet valve is installed along a section of the air inlet, an upper air supply line valve is installed along a section of the upper air supply line, and a lower air supply line valve is installed along a section of the lower air supply line, wherein the upper air supply line includes vented holes for blowing air downward and the lower air supply line includes vented holes for blowing air upward.

2. A method of automatically cleaning a cylindrical air filter comprising:
providing a cylindrical air filter to be cleaned;
supplying air from an external air source;
cleaning the cylindrical air filter with the automatic cylindrical air filter cleaning device, wherein the automatic cylindrical air filter cleaning device comprises a support frame, two parallel rollers mounted to the support frame for receiving the cylindrical air filter, a V-belt drive motor-and-pulley assembly mounted to the support frame, wherein the V-belt is fastened to the parallel rollers to permit their rotation and the rotation of the cylindrical air filter upon activation of the motor, and an air supply apparatus mounted to the support frame for receiving the air from the external air source and dispensing it to dislodge dust and particulate matter from the cylindrical air filter when placed and rotated on the rotating parallel rollers, wherein the air supply apparatus comprises an air inlet into which air supplied from the external air source flows, an upper air supply line over which the cylindrical air filter is slid when placed on the parallel rollers, and a lower air supply line, wherein an air inlet valve is installed along a section of the air inlet, an upper air supply line valve is installed along a section of the, upper air supply line, and a lower air supply line valve is installed along a section of the lower air supply line, wherein the upper air supply line includes vented holes for blowing air downward and the lower air supply line includes vented holes for blowing air upward.
